(19) United States
(12) Patent Application Publication
(10) Pub. No.: US 2010/0150265 A1
(43) Pub. Date: Jun. 17, 2010

(54) ANTENNA SELECTION METHOD AND RADIO COMMUNICATION DEVICE

(75) Inventors: Qiang Wu, Beijing (CN); Jifeng Li, Yokohama-shi (JP)

Correspondence Address: Christensen O'Connor Johnson Kindness PLLC, 1420 Fifth Avenue, Suite 2800, Seattle, WA, 98101-2347, US

(73) Assignee: MATSUSHITA ELECTRIC INDUSTRIAL CO., LTD., Kadoma-shi, Osaka (JP)

(21) Appl. No.: 12/088,664

(22) PCT Filed: Sep. 29, 2006
(86) PCT No.: PCT/JP2006/319556

§ 371 Date: Mar. 28, 2008

(30) Foreign Application Priority Data
Sep. 30, 2005 (CN) 200510108560.X

(51) Int. Cl. H04L 25/02; H04L 27/00

(52) U.S. Cl. 375/296; 375/295

(57) ABSTRACT

There is provided an antenna selection method and others capable of reducing a transmission error ratio and a calculation amount. In this method, a reception side feeds back M-column channel estimation matrix H_e to a transmission side (ST701). Next, the number K of the emission antennas is confirmed. When I=1 (that is, when the first antenna is selected), it is initialized and the emission channel matrix H is initialized by “0” (ST702). Next, it is judged whether I<K (ST703). If the judgment result is “NO”, the antenna selection process is terminated and the channel matrix H is outputted (ST704). If I<K, one column is added to the channel matrix H to constitute H1 and QR decomposition is performed for all the possible (M−I+1) H1 before selecting one H1 from all the H1 (ST705). Next, H=H1 is set and control is returned to ST703 (ST706).

### TECHNICAL FIELD

The present invention relates to an antenna selection method and radio communication apparatus, and more particularly to an antenna selection method and radio communication apparatus that are applied to a MIMO (Multi Input Multi Output) detection method, and enable the transmission error rate and processing calculation amount to be reduced.

### BACKGROUND ART

Multi Input Multi Output (MIMO) technique is a major advance in the field of radio mobile communication technology. MIMO technique refers to a technique in which a plurality of antennas are used in both transmission and reception of data. Research shows that the use of MIMO technique enables channel capacity and reliability to be improved and the bit error rate to be reduced. The upper limit of capacity in a MIMO system increases linearly with an increase in the number of antennas on the transmitting side or the number of antennas on the receiving side, whichever is smaller. In contrast, the upper limit of capacity of a normal intelligent antenna system using a multiantenna arrangement or an array antenna on the receiving side or on the transmitting side increases as the logarithm of the number of antennas. Therefore, MIMO technique has very great potential for improving the capacity of a radio communication system, and is an important technique for use by next-generation mobile communication systems.

FIG. 1 is a block diagram showing the configuration of a typical MIMO radio communication system 100 using MIMO technique. In this configuration, the transmitting side and receiving side perform transmission and reception using n_{T} and n_{R} antennas respectively. A serial/parallel conversion section 101 and a plurality of transmitting antennas 102-1, 102-2, . . . , 102-n_{T} are provided on the transmitting side. A plurality of receiving antennas 103-1, . . . , 103-n_{R}, a channel estimation section 104, and a MIMO detection section 105 are provided on the receiving side.

On the transmitting side, transmission data is first divided into n_{T} data streams by serial/parallel conversion section 101, and each data stream corresponds to one antenna 102. On the receiving side, n_{R} receiving antennas 103 receive signals, and channel estimation section 104 performs channel estimation based on the received signals and obtains a channel estimation matrix H_e. MIMO detection section 105 performs MIMO detection on the received signals using channel estimation matrix H_e, demodulates the signals transmitted from the transmitting side, and obtains detected data.

In a MIMO system, the cost of radio frequency (RF) related equipment is high, and the cost of a MIMO system, as well as the amount of processing calculation, increases as the number of antennas increases. Consequently, methods of selecting transmitting antennas in a MIMO system have appeared. For example, by selecting only K antennas with comparatively good channel performances from among M transmitting antennas (where M is a natural number greater than 1), the quantity of RF-related equipment can be reduced, together with cost.

There are several possible transmitting antenna selection methods for use in a MIMO radio communication system, as described below.

1. Itinerant Transmitting Antenna Selection Method Based on Capacity Maximization

The total number of possible combinations when K transmitting antennas are selected from among M transmitting antennas is C_{M}^{K} (for which the notation _{M}Cₖ may also be used). In an itinerant transmitting antenna selection method based on capacity maximization, these C_{M}^{K} combinations are traversed in accordance with a capacity computing equation—that is, a round of calculation is performed for all system capacities using all the combinations—and the combination for which the capacity is greatest is selected.

2. Transmitting Antenna Selection Method Based on Matrix Simplification

As the itinerant transmitting antenna selection method based on capacity maximization in 1. above involves a very large amount of calculation, Gorokhov has proposed a sequential elimination transmitting antenna selection method based on matrix simplification. In the method proposed by Gorokhov, based on the principle of matrix calculations, candidate transmitting antennas are sequentially eliminated one by one from M antennas until K transmitting antennas remain. The basis for this elimination is to minimize the reduction in system capacity due to elimination.

3. Norm-Based Transmitting Antenna Selection Method

In a norm-based transmitting antenna selection method, K columns (or rows) for which the norm is largest are selected from among all the columns (or rows), M columns (or rows), of a channel estimation matrix, and transmitting antennas corresponding to the selected columns (or rows) are selected as emission antennas used for transmission. This method is simpler than the two methods described above, but also has inferior performances.

### DISCLOSURE OF INVENTION

### Problems to be Solved by the Invention

None of the above-described conventional transmitting antenna selection methods takes the MIMO detection method on the radio receiving side into consideration. Therefore, a further reduction in the transmission error rate is anticipated by selecting transmitting antennas through adaptation to the MIMO detection method on the radio receiving side.

It is an object of the present invention to provide an antenna selection method and radio communication apparatus adapted to a receiving-side determination feedback MIMO detection method, that enable the transmission error rate and amount of calculation to be reduced.

### Means for Solving the Problems

One aspect of an antenna selection method of the present invention is an antenna selection method that is used in a MIMO (Multi Input Multi Output) radio communication system and includes: a first step of arbitrarily selecting K columns (where K is a natural number greater than 0 and less than or equal to M) from an M-column channel estimation matrix composed of M transmitting antennas (where M is a natural number greater than 1) and configuring C_{M}^{K} selection determination channel matrices; a second step of performing QR decomposition respectively on the C_{M}^{K} selection determination channel matrices and obtaining C_{M}^{K} upper triangular matrices; a third step of finding a diagonal element minimum modular value of each of the C_{M}^{K} upper triangular matrices; a fourth step of selecting one upper triangular matrix for which the diagonal element minimum modular value is largest from among the C_{M}^{K} upper triangular matrices; and a fifth step of selecting K transmitting antennas composing a selection determination channel matrix corresponding to an upper triangular matrix selected in the fourth step as emission antennas.

Another aspect of the present invention is an antenna selection method that is used in a MIMO communication system and includes: a first step of selecting columns corresponding to already selected I−1 emission antennas (where I is a natural number greater than 0) from an M-column channel estimation matrix composed of all of M transmitting antennas (where M is a natural number greater than 1) and configuring an I−1-column emission channel matrix; a second step of selecting columns corresponding to M−I+1 candidate transmitting antennas other than the I−1 emission antennas from the channel estimation matrix and configuring an M−I+1-column candidate channel matrix; a third step of adding one arbitrary column of the candidate channel matrix to the emission channel matrix and configuring M−I+1 selection determination channel matrices; a fourth step of performing QR decomposition on the M−I+1 selection determination channel matrices and obtaining M−I+1 upper triangular matrices; a fifth step of finding a diagonal element minimum modular value of each of the M−I+1 upper triangular matrices; a sixth step of selecting one upper triangular matrix for which the diagonal element minimum modular value is largest from among the M−I+1 upper triangular matrices; and a seventh step of selecting one candidate transmitting antenna composing a selection determination channel matrix corresponding to an upper triangular matrix selected in the sixth step as an I'th emission antenna; wherein the first step, the second step, the third step, the fourth step, the fifth step, the sixth step, and the seventh step are repeated K times (where K is a natural number greater than 0), and emission antennas are selected one by one up to K emission antennas.

### ADVANTAGEOUS EFFECT OF THE INVENTION

The present invention reduces the transmission error rate and the amount of processing calculation by selecting transmitting antennas on the transmitting side through adaptation to a receiving-side feedback determination MIMO detection method.

### BRIEF DESCRIPTION OF DRAWINGS

FIG. 1 is a block diagram showing the configuration of a conventional MIMO radio communication system;

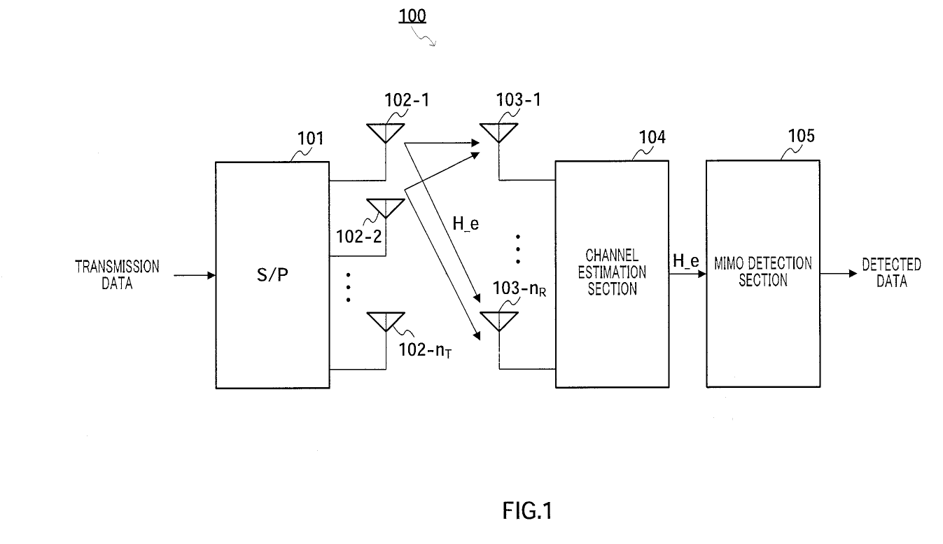

FIG. 2 is a block diagram showing the main configuration of a MIMO radio communication system according to Embodiment 1 of the present invention;

FIG. 3 is a block diagram showing the main configuration of a MIMO radio communication system according to Embodiment 2 of the present invention;

FIG. 4 is a flowchart showing the procedure of an antenna selection method of a transmitting antenna selection section according to Embodiment 2 of the present invention;

FIG. 5 is a flowchart summarizing the procedure of an antenna selection method of a transmitting antenna selection section according to this embodiment;

FIG. 6 is a graph comparing the BER performance of different transmitting antenna selection methods;

FIG. 7 is a graph comparing the BER performance of different transmitting antenna selection methods; and

FIG. 8 is a block diagram showing the main configuration of a MIMO radio communication system according to Embodiment 3 of the present invention.

### BEST MODE FOR CARRYING OUT THE INVENTION

Embodiments of the present invention will now be described in detail with reference to the accompanying drawings.

### Embodiment 1

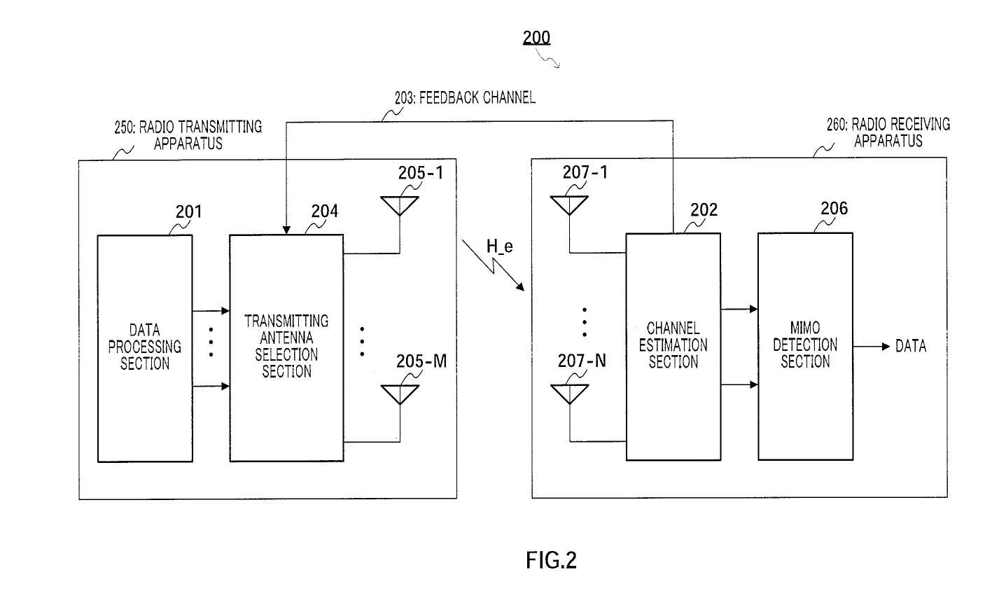

FIG. 2 is a block diagram showing the main configuration of a MIMO radio communication system 200 according to Embodiment 1 of the present invention. In FIG. 2, MIMO radio communication system 200 includes a radio transmitting apparatus 250 and a radio receiving apparatus 260. For brevity, only configuration elements related to transmitting antenna selection will be described here. Radio transmitting apparatus 250 is equipped with a data processing section 201, a transmitting antenna selection section 204, and M transmitting antennas 205-1 through 205-M. Radio receiving apparatus 260 is equipped with N receiving antennas 207-1 through 207-N, a channel estimation section 202, and a MIMO detection section 206.

In radio transmitting apparatus 250, data processing section 201 performs processing such as serial/parallel conversion, encoding, and modulation on data, and outputs the obtained data stream to transmitting antenna selection section 204. Transmitting antenna selection section 204 selects K antennas to be used for transmitting from among the M transmitting antennas 205 based on channel estimation matrix H_e fed back from radio receiving apparatus 260. Hereinafter, the selected K transmitting antennas are referred to as emission antennas. Transmitting antenna selection section 204 transmits the data stream inputted from data processing section 201 via the selected K emission antennas.

In radio receiving apparatus 260, the N receiving antennas 207 receive a spatial signal containing a training sequence transmitted from transmitting antennas 205, and output this to channel estimation section 202. Channel estimation section 202 obtains channel estimation matrix H_e corresponding to all the transmitting antennas based on the training sequence, and periodically feeds back obtained channel estimation matrix H_e to transmitting antenna selection section 204 of radio transmitting apparatus 250 via a feedback channel 203. MIMO detection section 206 performs determination feedback MIMO detection, and detects data transmitted from radio transmitting apparatus 250.

The determination feedback MIMO detection method used by MIMO detection section 206 will now be described. In the determination feedback MIMO detection method used in MIMO detection section 206, when detecting the m'th data, the m'th data is estimated and detected after interference of the preceding m−1 data items is eliminated from the received signal using the determinations—that is, estimation results—of the preceding m−1 data items. That is to say, a characteristic of the determination feedback MIMO detection method is that determination results of previous data are fed back and used recursively in data detection. Here, a detailed explanation will be given of a MIMO detection method based on QR decomposition, which is a typical example of a determination feedback MIMO detection method.

In MIMO radio communication system 200, a received signal is indicated by Equation (1) below.

y=H_{—}es+n (1)

In this equation, s denotes a transmission signal, y denotes a received signal, H_e denotes a channel estimation matrix, and n denotes white Gaussian noise. In a MIMO detection method based on QR decomposition, channel estimation matrix H_e undergoes QR decomposition in accordance with Equation (2) below.

H_{—}e=QR (2)

In this equation, matrix Q is a unitary matrix—that is, a matrix that satisfies the condition Q^{H}Q=I_{nt×nt}, where Q^{H} denotes a complex conjugate transposition matrix of unitary matrix Q—and R is an upper triangular matrix.

By multiplying left-hand received signal y shown in Equation (1) by Q^{H}, Equation (3) and Equation (4) below are obtained.

$$\begin{matrix}z = {Q}^{H} y = Rs + η & ( 3 ) \\ {\hat{s}}_{i} = Q ( \frac{{z}_{i} - {\sum }_{j = i + 1}^{{n}_{T}} {R}_{i , j} {\hat{s}}_{j}}{{R}_{i , i}} ) & ( 4 )\end{matrix}$$

In Equation (3), η=Q^{H}n, and its statistical characteristic is the same as for white Gaussian noise n. In Equation (4), Q indicates demodulation.

Utilizing the characteristics of upper triangular matrix R, MIMO detection section 206 performs detection of transmission signal s from the end (last item) of upper triangular matrix R. That is to say, first, in accordance with Equation (4), estimation value ŝ_{M} of transmission signal s_{M} transmitted from the M'th transmitting antenna (the total number of transmitting antennas being M) is obtained, and based on ŝ_{M}, transmission signal s_{M-1} transmitted from transmitting antenna M−1 is estimated and estimation value ŝ_{M-1} is obtained. Similarly, when estimating transmission signal sₙ₋₁ transmitted from the m'th transmitting antenna, estimation value ŝₘ is obtained using estimation values ŝₘ₊₁ through ŝ_{M} of transmission data m+1 through M. By repeating this kind of estimation, transmission signals transmitted from all transmitting antennas from the M'th to the 1st are estimated.

A description will now be given of an antenna selection method according to this embodiment adapted to a determination feedback MIMO detection method such as described above. Specifically, as an example, a description will be given of an antenna selection method based on QR decomposition in transmitting antenna selection section 204 of radio transmitting apparatus 250 corresponding to a case in which MIMO detection based on QR decomposition is performed in radio receiving apparatus 260.

When number of receiving antennas 207 N=2, and number of transmitting antennas 205 M=4, channel estimation matrix H_e is an N×M (2×4) matrix. Based on channel estimation matrix H_e fed back from channel estimation section 202 of radio receiving apparatus 260, transmitting antenna selection section 204 of radio transmitting apparatus 250 selects K antennas from among the M transmitting antennas as emission antennas. Since each column of channel estimation matrix H_e corresponds to a transmitting antenna, selecting K antennas from among the M transmitting antennas means selecting K columns (where K columns correspond to K transmitting antennas) from the M columns of H_e, and the N×K matrix comprising the selected K columns is designated selection determination channel matrix H_c.

There are _{M}Cₖ (for which the notation C_{M}^{K} may also be used) ways of selecting K transmitting antennas from among the M transmitting antennas in transmitting antenna selection section 204—that is, C_{M}^{K} selection determination channel matrices H_c can be configured. Transmitting antenna selection section 204 performs QR decomposition for the C_{M}^{K} possible H_c's, and obtains C_{M}^{K} upper triangular matrices R as C_{M}^{K} mutually different QR decomposition results. Then transmitting antenna selection section 204 finds minimum value of the diagonal element modular (the diagonal element minimum modular value) in each R. Next, one upper triangular matrix R for which the diagonal element minimum modular value is largest is selected from among the C_{M}^{K} upper triangular matrices R. By this means, an H_c corresponding to the selected R—that is, an H_c that satisfies Equation (5)—is decided. When H_c is decided, K emission antennas corresponding to H_c are decided.

$$H = arg {max}_{H} min \{ {R}_{11}^{2} , … , {R}_{KK}^{2} \} \qquad ( 5 )$$

Rₖₖ: Diagonal element of upper triangular matrix R (1≦k≦K)

In order to explain the effects of an antenna selection method according to this embodiment, a case in which transmission is performed without transmission errors will be described. In such a case, the reception SNR (Signal to Noise Ratio) of a transmission signal transmitted from the k'th emission antenna (where 1≦k≦K) obtained by performing MIMO detection based on QR decomposition in radio receiving apparatus 260 is shown by Equation (6) below.

$${SNR}_{k} = \frac{E \{ {\vert {s}_{k} \vert}^{2} \} {\vert {R}_{kk} \vert}^{2}}{E \{ {\vert {n}_{k} \vert}^{2} \}} \qquad ( 6 )$$

Rₖₖ: Diagonal element of upper triangular matrix R (1≦k≦K)

E{|sₖ|²}: Average transmission power of k'th antenna (1≦k≦K)

E{|nₖ|²}: Average noise power of k'th antenna (1≦k≦K)

As shown by this equation, reception SNRₖ is proportional to |Rₖₖ|². Since most errors usually occur in transmission from the transmitting antenna with the poorest performance, the overall system error rate can be improved by improving the performance of the transmitting antenna with the poorest performance as far as possible. With an antenna selection method based on QR decomposition according to this embodiment, the error rate is improved by making the minimum SNRₖ as large as possible—that is, by making the minimum |Rₖₖ|² in Equation (6) as large as possible. Specifically, when selecting K columns from among the M columns of channel estimation matrix H_e, there are C_{M}^{K} possibilities, and C_{M}^{K} selection determination channel matrices H_c are configured. QR decomposition is performed on these C_{M}^{K} H_c's, and the minimum value of |Rₖₖ|² in each upper triangular matrix R is found. Then the largest of the found C_{M}^{K} minimum values is selected, and the corresponding R and H_c—that is, an H_c that satisfies Equation (5)—are obtained.

Thus, according to this embodiment, in a MIMO radio communication system, a transmitting antenna selection section arbitrary selects K columns from the M columns of a channel estimation matrix and configures a plurality of selection determination channel matrices H_c, and selects transmitting antennas based on QR decomposition of the configured plurality of selection determination channel matrices H_c, thereby enabling the transmission error rate to be reduced.

In this embodiment, a case in which the transmitting antenna selection section performs transmitting antenna selection based on QR decomposition has been described as an example, but this embodiment may be modified as appropriate and adapted to another determination feedback MIMO detection method used in the MIMO detection section.

### Embodiment 2

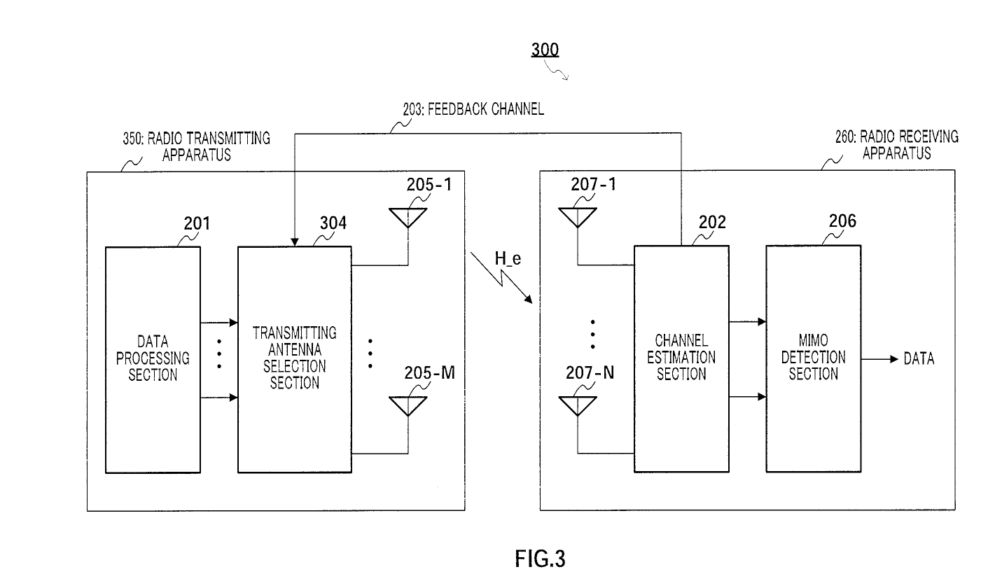

FIG. 3 is a block diagram showing the main configuration of a MIMO radio communication system 300 according to Embodiment 2 of the present invention. MIMO radio communication system 300 has the same basic configuration as MIMO radio communication system 200 shown in Embodiment 1 (see FIG. 2), and therefore identical configuration elements are assigned the same reference numerals, and descriptions thereof are omitted.

There is a difference in part of the processing of transmitting antenna selection section 304 of MIMO radio communication system 300 and transmitting antenna selection section 204 of MIMO radio communication system 200, and different reference numerals are assigned to indicate this, in addition to which different reference numerals are also assigned to a radio transmitting apparatus 350 of MIMO radio communication system 300 and radio transmitting apparatus 250 of MIMO radio communication system 200.

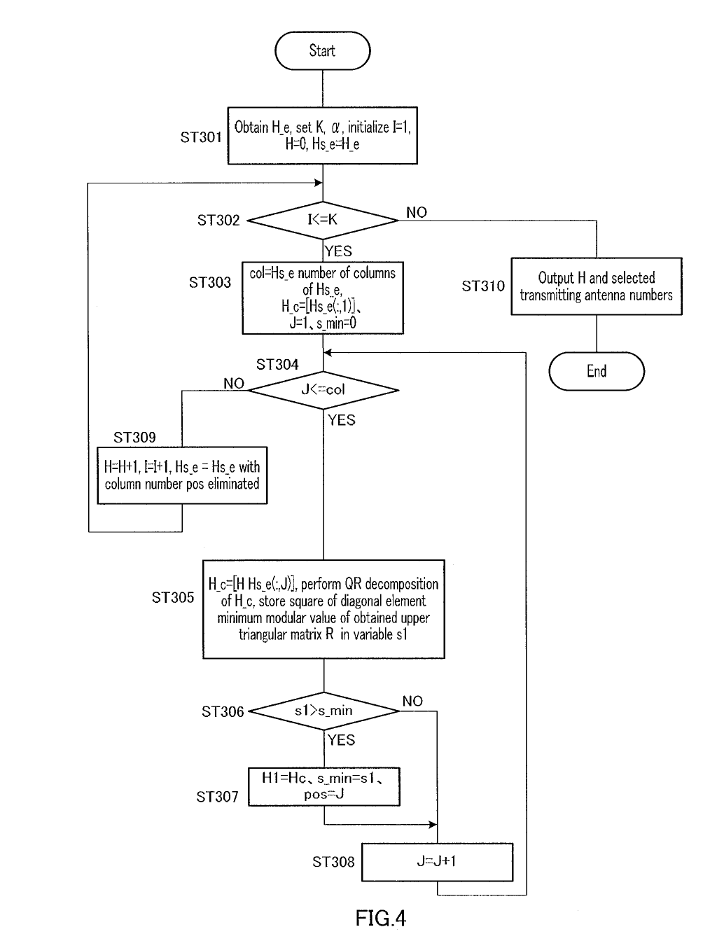

FIG. 4 is a flowchart showing the procedure of an antenna selection method used by transmitting antenna selection section 304. In the description of the antenna selection method used by transmitting antenna selection section 304, also, a case in which K antennas are selected from among M transmitting antennas is taken as an example.

First, instep (hereinafter abbreviated to “ST”) 301, transmitting antenna selection section 304 obtains channel estimation matrix H_e fed back from the radio receiving apparatus 260 side, and performs initialization so that I=1 (that is, the first emission antenna is selected), H=0, and Hs_e=H_e. Here, I is a counter that counts K emission antennas from 1 to K, and H denotes an emission channel matrix composed of the selected I−1 emission antennas. Hs_e denotes a matrix obtained by eliminating columns corresponding to the selected I−1 emission antennas. That is to say, Hs_e is an N×(M−I+1) channel matrix composed of M−I+1 candidate transmitting antennas other than the I−1 emission antennas selected from among the M transmitting antennas, and is hereinafter referred to as a candidate channel matrix.

Next, in ST302, transmitting antenna selection section 304 compares I and K.

If it is determined in ST302 that I>K (ST302: NO), transmitting antenna selection section 304 determines that all K emission antennas have been selected, and directs the processing procedure to ST310.

Then, in ST310, transmitting antenna selection section 304 outputs the selected K emission antenna numbers and channel matrix H composed of K emission antennas.

If it is determined in ST302 that I≦K (ST302: YES), the processing proceeds to ST303.

Next, in ST303, transmitting antenna selection section 304 sets col using the number of columns of candidate channel matrix Hs_e composed of candidate transmitting antennas, and initializes variables J and s_min so that J=1 and s_min=0, where J is a counter that counts M−I+1 candidate transmitting antennas from 1 to M−I+1 in the selection processing of the I'th emission antenna, and s_min is a variable for storing the largest value from among the diagonal element minimum modular values of upper triangular matrices R obtained by QR decomposition. In this step, also, transmitting antenna selection section 304 initializes selection determination channel matrix H_c using a channel matrix composed of the selected I−1 emission antennas and the first of the M−I+1 candidate transmitting antennas. That is to say, transmitting antenna selection section 304 adds the first column of candidate channel matrix Hs_e to channel matrix H and initializes selection determination channel matrix H_c using the obtained channel matrix. Here, selection determination channel matrix H_c is a channel matrix obtained by adding the column corresponding to antenna number J(1≦J≦M−I+1) from among the M−I+1 candidate transmitting antennas—that is, column number J(1≦J≦M−I+1) of candidate channel matrix Hs_e—to channel matrix H composed of the selected I−1 emission antennas. If the J'th column of Hs_e is denoted by Hs_e(:,J), and H_c=[H Hs_e(:,J)] or [Hs_e(:,J)H] is denoted, in this step the initialization of H_c is denoted by H_c=[H Hs_e(:,1)].

Next, in ST304, transmitting antenna selection section 304 determines whether or not J≦col.

If it is determined in ST304 that J≦col (ST304: YES), the processing proceeds to ST305.

Then, in ST305, selection determination channel matrix H_c=[H Hs_e(:,J)] is configured by adding the column corresponding to antenna number J(1≦J≦M−I+1) from among the M−I+1 candidate transmitting antennas—that is, column number J(1≦J≦M−I+1) of candidate channel matrix Hs_e—to channel matrix H composed of the selected I−1 emission antennas. Here, there are a total of M−I+1 H_c's for a fixed I, one of which is selected by means of loop processing of ST304 through ST308. Transmitting antenna selection section 304 selects the candidate transmitting antenna composing H_c selected by means of these steps as the I'th emission antenna. Transmitting antenna selection section 304 performs QR decomposition of H_c obtained in these steps, and stores the square of the diagonal element minimum modular value of the obtained upper triangular matrix R in variable s1.

In ST306, transmitting antenna selection section 304 determines whether or not s1>s_min. Here, s_min is a variable for storing the largest value from among the diagonal element minimum modular values of the M−I+1 upper triangular matrices R obtained by QR decomposition. That is to say, in this step, s_min stores the largest of the J s1's corresponding to the J H_c's calculated thus far.

If it is determined in ST306 that s1>s_min (ST306: YES), the processing proceeds to ST307.

Next, in ST307, the J'th antenna of the M−I+1 candidate transmitting antennas is tentatively determined to be the I'th emission antenna, and H1 is set using the relevant H_c. Here, H1 is a channel matrix composed of transmitting antennas tentatively determined to be the I'th emission antenna, and will here be referred to as a tentative emission channel matrix. In this step, also, transmitting antenna selection section 304 updates s_min so that s_min=s1, and sets pos=J, where pos is a variable for storing the ordinal number among the M−I+1 candidate transmitting antennas of a transmitting antenna tentatively determined to be the I'th emission antenna.

Then, in ST308, transmitting antenna selection section 304 sets J=J+1 and returns the processing procedure to ST304.

If it is determined in ST306 that s1≦s_min (ST306: NO), the processing proceeds to step ST308.

If it is determined in ST304 that J>col (ST304: NO), transmitting antenna selection section 304 determines that ST304 through ST308 loop processing has been completed for all the M−I+1 candidate transmitting antennas, and directs the processing procedure to ST309.

Next, in ST309, transmitting antenna selection section 304 sets H=H+1 and I=I+1, updates Hs_e by eliminating column number pos from Hs_e, and returns the processing procedure to ST302.

As an example of transmitting antenna selection according to the procedure shown in FIG. 4, a case will be described in which number of receiving antennas N=2, and K antennas are selected from M=4 transmitting antennas. In this case, channel estimation matrix H_e is an N×M (2×4) matrix, and the number of ways of selecting the first (I=1) emission antenna is M (M=4), corresponding to four 2×1 matrices H_c. When QR decomposition is performed on four H_c's, four R's are obtained. As each of these four Rs's is a 1×1 matrix, the diagonal element minimum modular value in each R is R itself. By selecting the largest of these four minimum modular values, the H_c corresponding thereto can be found. The transmitting antenna corresponding to one column composing this found H_c is the first emission antenna selected by transmitting antenna selection section 304. Next, the second (I=2) emission antenna is selected. When selecting the second emission antenna, there are three selection possibilities (there are M−I+1 ways of selecting the I'th emission antenna), corresponding to M−1 H2's, with H2 being N×2 (Hk being N×k). The second emission antenna is selected from the three possibilities using the same method as for selecting the first emission antenna described above.

The antenna selection method shown in the flowchart in FIG. 4 is illustrated below using an actual numeric example of a channel estimation matrix.

For channel estimation matrix H_e, it is here assumed that H e=−0.2163+0.1636i 0.0627−0.0934i −0.5732−0.2942i 0.5946−0.0682i −0.8328+0.0873i 0.1438+0.3629i 0.5955+1.0916i −0.0188+0.0570i

First, transmitting antenna selection section 304 selects the first (I=1) emission antenna. At the start of the processing procedure, transmitting antenna selection section 304 performs initialization so that H is a null set and Hs_e=H_e. As indicated in the description of ST305 in FIG. 4, for H_c=[H Hs_e(:,J)] (1≦J≦M−I+1), there are 4 (M−I+1=4) possibilities, corresponding to 4 columns of Hs_e. QR decomposition is performed on the four H_c's, and the following four upper triangular matrices R are obtained: R1=0.8802, R2=−0.4062, R3=1.4005, R4=−0.6015.

As H_c is a 1-column matrix, upper triangular matrices R (R1 through R4) are single numeric values, and the diagonal element minimum modular value is the numeric value itself. The squares of the four diagonal element minimum modular values are 0.7747, 0.1650, 1.9613, and 0.3618, and the column of Hs_e corresponding to the largest of these values, 1.9613, is as follows:
−0.5732−0.2942i
0.5955+1.0916i

This is the third column of Hs_e. Thus, transmitting antenna selection section 304 selects the third transmitting antenna of the M=4 transmitting antennas as the first (I=1) emission antenna.

In ST309, transmitting antenna selection section 304 makes the following setting:
H=H1=−0.5732−0.2942i 0.5955+1.0916i

As described above, H is a channel matrix composed of 1 (I=1) selected transmitting antenna. In this step, also, transmitting antenna selection section 304 eliminates the third column of Hs_e, and obtains the following:
Hs_e=−0.2163+0.1636i 0.0627−0.0934i 0.5946−0.0682i −0.8328+0.0873i 0.1438+0.3629i −0.0188+0.0570i

After the first (1=1) emission antenna is selected, the second (I=2) emission antenna is selected. In this case, there are 3 (M−I+1=3) possibilities for H_c=[H Hs_e(:,J)] (1≦J≦M−I+1), and upper triangular matrices R1 through R3 obtained by QR decomposition of the three H_c's (H_c1 through H_c3) are as follows.
For upper triangular matrix R1 corresponding to H_c1=−0.5732−0.2942i −0.2163+0.1636i 0.5955+1.0916i −0.8328+0.0873i
R1=1.4005−0.2319+0.5738i 0 0.6258
and therefore the square of the diagonal element minimum modular value is ss1=0.3917.
For upper triangular matrix R2 corresponding to H_c2=−0.5732−0.2942i 0.0627−0.0934i 0.5955+1.0916i 0.1438+0.3629i
R2=1.4005 0.3380+0.0936i 0−0.2050
and therefore the square of the diagonal element minimum modular value is ss2=0.0420.
For upper triangular matrix R3 corresponding to H_c3=−0.5732−0.2942i 0.5946−0.0682i 0.5955+1.0916i−0.0188+0.0570i
R3=1.4005−0.1926+0.1917i −0.5366
and therefore the square of the diagonal element minimum modular value is ss3=0.2879.

Since the largest of values ss1 through ss3 is ss1, transmitting antenna selection section 304 selects the transmitting antenna corresponding to ss1—that is, the first (J=1) of the 3 (M−I+1) candidate transmitting antennas—as the second (I=2) emission antenna.

An antenna selection method according to this embodiment can be summarized as follows.
1) MIMO detection section 206 performs determination feedback type MIMO detection.
2) Transmitting antenna selection section 304 obtains channel estimation matrix H_e by means of radio receiving apparatus 260 feedback.
3) The number of emission antennas selected by transmitting antenna selection section 304 is K.
4) QR decomposition is performed on selection determination channel matrices H_c composed of a selected emission antenna and each candidate transmitting antenna, and a unitary matrix Q and upper triangular matrix R corresponding to each are obtained. Then transmitting antenna selection section 304 finds a diagonal element minimum modular value in each R, selects the largest thereof, and finds an R and H_c corresponding thereto. That is to say, one H_c that satisfies Equation (5) is found. Transmitting antenna selection section 304 takes a candidate transmitting antenna composing the found H_c as an emission antenna to be selected.
5) Emission antennas up to K in number are selected one by one by repeating the processing in 4).

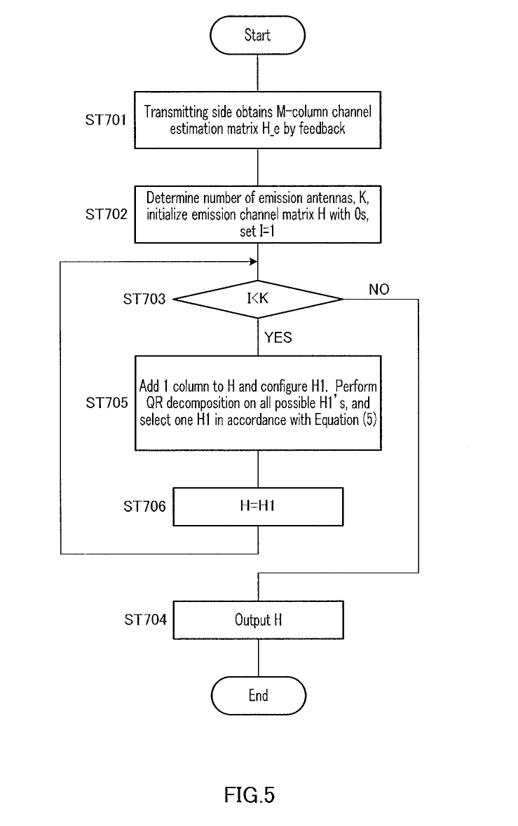

FIG. 5 is a flowchart summarizing the procedure of an antenna selection method according to this embodiment.

First, in ST701, an M-column channel estimation matrix H_e is fed back to the transmitting side from the receiving side. Then, in ST702, the number of emission antennas, K, is determined, emission channel matrix H is initialized with 0s, and I=1 is set (that is, the first antenna is to be selected). Next, in ST703, it is determined whether or not I<K, and if the determination result is “NO”, antenna selection processing is terminated, and channel matrix H is output in ST704. If the determination result in ST703 is “YES”, the processing proceeds to step ST705, one column is added to channel matrix H, and H1 is configured. QR decomposition is performed on all (M−I+1) possible H1's, and one H1 is selected from among all the H1's in accordance with Equation (5). Then H=H1 is set in ST706. Next, the processing procedure returns to ST703, and ST703 through ST706 are repeated until K emission antennas have been selected.

To put the explanation in the flowchart in FIG. 5 in other words, an antenna selection method according to this embodiment is an antenna selection method that is used in a MIMO (Multi Input Multi Output) radio communication system and includes: a first step of selecting columns corresponding to already selected I−1 emission antennas (where I is a natural number greater than 0) from an M-column channel estimation matrix composed of all of M transmitting antennas (where M is a natural number greater than 1) and configuring an (I−1)-column emission channel matrix; a second step of selecting columns corresponding to M−I+1 candidate transmitting antennas other than the I−1 emission antennas from the channel estimation matrix and configuring an (M−I+1)-column candidate channel matrix; a third step of adding one arbitrary column of the candidate channel matrix to the emission channel matrix and configuring M−I+1 selection determination channel matrices; a fourth step of performing QR decomposition on the M−I+1 selection determination channel matrices and obtaining M−I+1 upper triangular matrices; a fifth step of finding a diagonal element minimum modular value of each of the M−I+1 upper triangular matrices; a sixth step of selecting one upper triangular matrix for which the diagonal element minimum modular value is largest from among the M−I+1 upper triangular matrices; and a seventh step of selecting one candidate transmitting antenna composing a selection determination channel matrix corresponding to an upper triangular matrix selected in the sixth step as a first emission antenna; wherein the first step, the second step, the third step, the fourth step, the fifth step, the sixth step, and the seventh step are repeated K times (where K is a natural number greater than 0), and emission antennas are selected one by one up to K emission antennas.

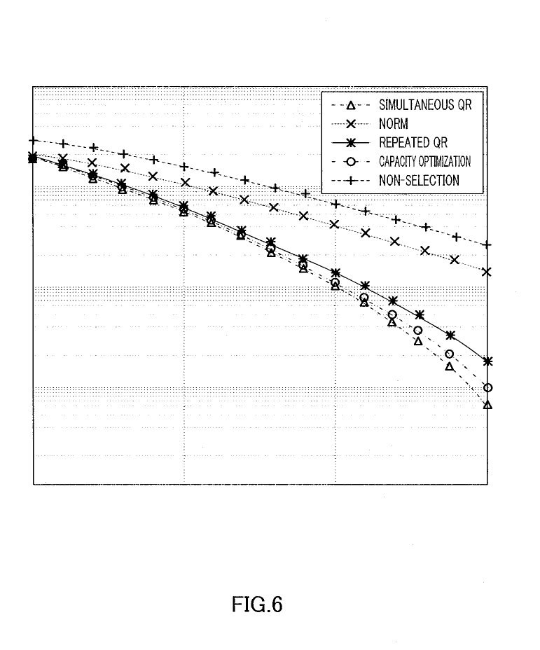

FIG. 6 is a graph comparing BER (Bit Error Rate) performance obtained when transmitting antenna selection is performed using different antenna selection methods in a MIMO radio communication system in which MIMO detection is performed based on QR decomposition. In a simulation, the modulation method is 16-QAM, number of receiving antennas N=2, number of transmitting antennas M=4, and K=2 emission antennas are selected.

In FIG. 6, “Simultaneous QR” shows BER performance obtained when using an antenna selection method according to Embodiment 1 of the present invention—that is, a method whereby QR decomposition is performed on selection determination channel matrices corresponding to C_{M}K selection ways and K emission antennas are selected simultaneously. “Norm” shows BER performance obtained when using a norm-based antenna selection method, and “Repeated QR” shows BER performance obtained when using an antenna selection method according to Embodiment 2 of the present invention—that is, a method whereby emission antennas up to K in number are selected one by one based on QR decomposition. “Capacity optimization” shows BER performance obtained when using an itinerant antenna selection method based on capacity optimization. In this figure, the graph labeled “Non-selection” indicates BER performance obtained when transmitting antenna selection is not performed and two (M=2) transmitting antennas are used directly as emission antennas.

As shown in FIG. 6, BER performance improves in the following order: “Non-selection”, “Norm”, “Repeated QR”, “Capacity optimization”, “Simultaneous QR”. Specifically, the BER performance of a “Norm” based transmitting antenna selection method does not show major improvement over the BER performance in the case of “Non-selection”, BER performance is almost the same for a “Simultaneous QR” transmitting antenna selection method and a “Capacity optimization” transmitting antenna selection method, and the BER performance of a “Repeated QR” transmitting antenna selection method is slightly poorer than the BER performance of a “Simultaneous QR” antenna selection method.

However, a “Repeated QR” antenna selection method is superior to a “Simultaneous QR” antenna selection method in requiring a smaller amount of calculation. The amount of calculation with a “Repeated QR” antenna selection method and the amount of calculation with a “Simultaneous QR” antenna selection method are described below.

The amount of calculation when QR decomposition is performed on an m×n matrix C is 2 mn². Therefore, when the number of receiving antennas is N and K emission antennas are selected from among M transmitting antennas, the amount of calculation with a “Simultaneous QR” antenna selection method is Cₘ^{K}×(2 NK²).

On the other hand, when a “Repeated QR” antenna selection method is used, transmitting antennas are selected one by one, and there are M selection possibilities when selecting the first antenna and M−I+1 selection possibilities when selecting the I'th antenna. In selection of the I'th antenna, the selection determination channel matrix on which QR decomposition is performed is N×I, and therefore the corresponding amount of QR decomposition calculation is (M−I+1)×(N×I²). Thus, the overall amount of calculation with a “Repeated QR” antenna selection method is as shown in Equation (7) below.

$${\sum }_{I = 1}^{K} ( M - I + 1 ) \times ( {NI}^{2} ) \qquad ( 7 )$$

The value shown in Equation (7) is smaller than C_{M}^{K}×(2 NK²). That is to say, the amount of calculation with a “Repeated QR” antenna selection method is less than the amount of calculation with a “Simultaneous QR” antenna selection method.

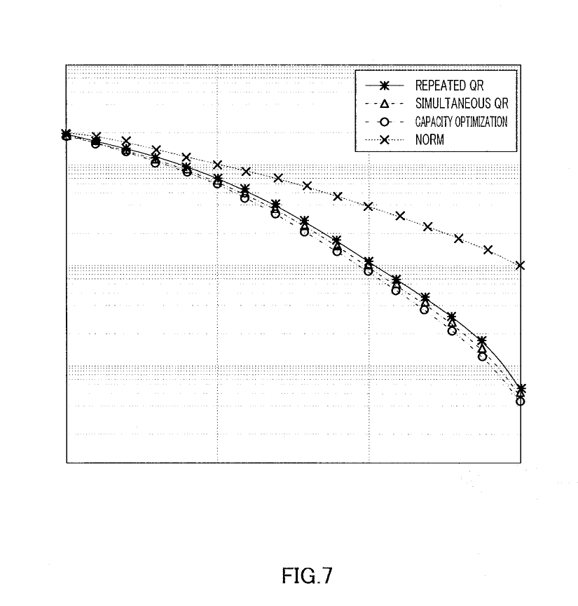

FIG. 7 is a graph comparing BER (Bit Error Rate) performance obtained when transmitting antenna selection is performed using different antenna selection methods in a MIMO radio communication system in which the receiving-side MIMO detection section performs MIMO detection based on SQR (sequencing QR).

As shown in FIG. 7, BER performance improves in the following order: “Norm”, “Repeated QR”, “Simultaneous QR”, “Capacity optimization”. Specifically, the BER performance of a “Norm” based transmitting antenna selection method is almost the same as the BER performance of the “Norm” based transmitting antenna selection method shown in FIG. 6, and the BER performance of a “Repeated QR” based transmitting antenna selection method is very close to the BER performance of a “Simultaneous QR” or “Capacity optimization” based transmitting antenna selection method. However, a “Repeated QR” based antenna selection method has the advantage of a smaller amount of calculation than a “Simultaneous QR” or “Capacity optimization” based transmitting antenna selection method. A detailed description is omitted here.

Thus, according to this embodiment, emission antennas are selected one by one up to K emission antennas based on QR decomposition, thereby enabling the transmission error rate to be reduced and the amount of calculation in antenna selection processing to be reduced.

### Embodiment 3

In this embodiment, a case is described in which power distribution is performed for selected transmitting antennas using the results of performing antenna selection based on QR decomposition.

First, the principle of performing power distribution in this embodiment will be explained.

After antenna selection has been performed using an antenna selection method according to Embodiment 1 or Embodiment 2 of the present invention, the radio transmitting apparatus can calculate the SNR of a signal transmitted from each emission antenna in accordance with Equation (6) using average noise power fed back from the radio receiving apparatus.

If A and σ are defined as shown in Equation (8) below,

E{|sₖ|²}−A², E{|nₖ|²} (8)

SNRₖ shown in Equation (6) is as shown in Equation (9) below.

$${SNR}_{k} = \frac{{A}^{2} {\vert {R}_{kk} \vert}^{2}}{{σ}^{2}} \qquad ( 9 )$$

Next, the radio transmitting apparatus of the MIMO radio communication system can perform power distribution for the respective emission antennas in accordance with the Water Filling principle. If the total power to be distributed to K emission antennas is designated Pₜₒₜₐₗ, transmission power P(k) distributed to each emission antenna based on Equation (8) and Equation (9) can be calculated by means of Equation (10) below.

$$\begin{matrix}P ( k ) = P + \frac{1}{K} {\sum }_{m = 1}^{K} \frac{1}{{SNR}_{m}} - \frac{1}{{SNR}_{k}} \\ = P + \frac{1}{K} {\sum }_{m = 1}^{K} \frac{{σ}^{2}}{{A}^{2} {R}_{mm}^{2}} - \frac{{σ}^{2}}{{A}^{2} {R}_{kk}^{2}}\end{matrix} \qquad ( 10 )$$

The SNR of each emission antenna is then calculated anew based on the power distribution results, and a modulation method used for data transmitted by each emission antenna is selected from an adaptive modulation parameter table based on the calculated new SNR values.

The configuration of a MIMO radio communication system according to this embodiment will now be described.

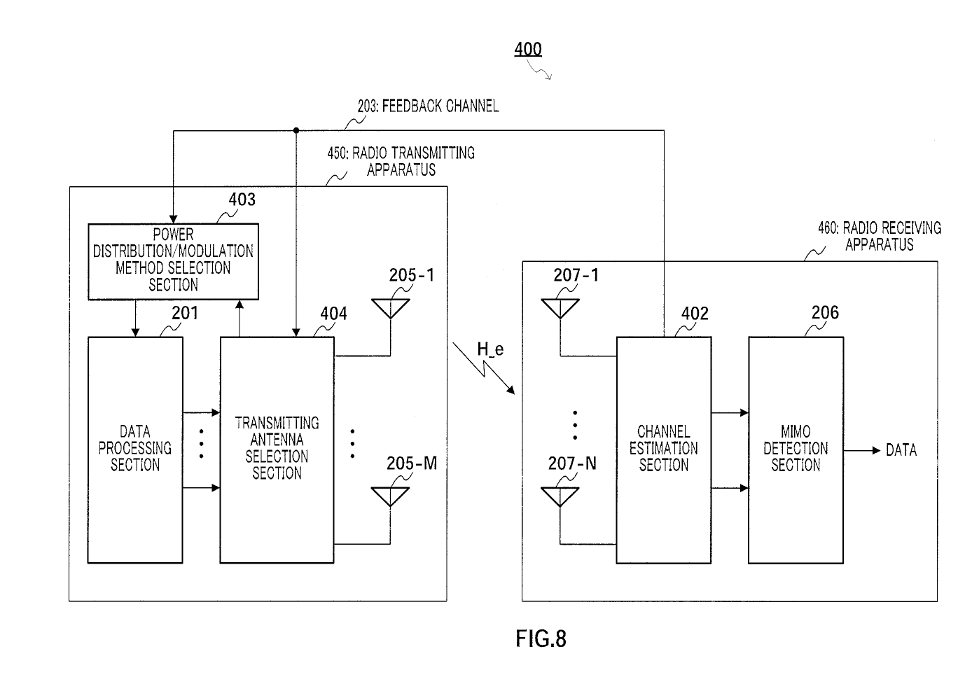

FIG. 8 is a block diagram showing the main configuration of a MIMO radio communication system 400 according to this embodiment. MIMO radio communication system 400 has the same basic configuration as MIMO radio communication system 300 shown in Embodiment 2 (see FIG. 3), and therefore identical configuration elements are assigned the same reference numerals, and descriptions thereof are omitted.

MIMO radio communication system 400 differs from MIMO radio communication system 300 in also including a power distribution/modulation method selection section 403. There is also a difference in part of the processing of channel estimation section 402 and transmitting antenna selection section 404 of MIMO radio communication system 400, and channel estimation section 202 and transmitting antenna selection section 304 of MIMO radio communication system 300, and different reference numerals are assigned to indicate this. In addition, different reference numerals are also assigned to a radio transmitting apparatus 450 and radio receiving apparatus 460 of MIMO radio communication system 400, and radio transmitting apparatus 350 and radio receiving apparatus 260 of MIMO radio communication system 300.

Channel estimation section 402 obtains channel estimation matrix H_e corresponding to all the transmitting antennas based on a training sequence transmitted from radio transmitting apparatus 450, and feeds back obtained channel estimation matrix H_e to transmitting antenna selection section 404 of radio transmitting apparatus 450 via feedback channel 203. Channel estimation section 402 also calculates average noise power σ², and and feeds this back to power distribution/modulation method selection section 403 of radio transmitting apparatus 450 via feedback channel 203.

Based on channel estimation matrix H_e fed back from radio receiving apparatus 460, transmitting antenna selection section 404 selects K transmitting antennas from among M transmitting antennas 207. Then transmitting antenna selection section 404 performs QR decomposition on a channel matrix composed of the selected K transmitting antennas, and outputs diagonal element Rₖₖ (k=1, 2, . . . , K) of upper triangular matrix R to power distribution/modulation method selection section 403. Power distribution/modulation method selection section 403 obtains SNRₖ (k=1, 2, . . . , K) of each pre-power-distribution transmitting antenna in accordance with Equation (9) using diagonal element Rₖₖ (k=1, 2, . . . , K) of upper triangular matrix R inputted from transmitting antenna selection section 404 and average noise power σ² inputted from channel estimation section 402. Next, power distribution/modulation method selection section 403 performs power distribution for the K emission antennas selected by transmitting antenna selection section 404 based on the Water Filling principle. By means of the power distribution processing performed by power distribution/modulation method selection section 403, power is distributed to the K emission antennas as shown in Equation (10). Power distribution/modulation method selection section 403 also calculates the SNR of each of the K emission antennas anew based on the power distribution results, and selects a modulation method corresponding to each emission antenna from an adaptive modulation parameter table based on the calculated new SNR values. Power distribution/modulation method selection section 403 outputs the selected modulation methods to data processing section 201. Data processing section 201 uses the modulation methods inputted from power distribution/modulation method selection section 403 when performing modulation processing.

That is to say, power distribution/modulation method selection section 403 executes power distribution/modulation method selection processing that includes: a step of configuring an emission channel matrix composed of K emission antennas; a step of performing QR decomposition on the emission channel matrix and obtaining an upper triangular matrix; a step of calculating the SNR (Signal to Noise Ratio) of the K emission antennas using a diagonal element modular value of an upper triangular matrix obtained in that step; and a step of performing power distribution and modulation method selection for the K emission antennas based on the SNR.

Thus, according to this embodiment, the SNR of a selected emission antenna is calculated anew based on the results of antenna selection based on QR decomposition, and power distribution is performed for each emission antenna based on the calculated SNR, thereby enabling the emission antenna bit error rate to be further reduced.

In this embodiment, a case has been described by way of example in which MIMO radio communication system 400 has the same basic configuration as MIMO radio communication system 300 shown in Embodiment 2 (see FIG. 3), but MIMO radio communication system 400 may also have the same basic configuration as MIMO radio communication system 200 shown in Embodiment 1 (see FIG. 2).

This concludes a description of the embodiments of the present invention.

An antenna selection method and radio communication apparatus according to the present invention are not limited to the above-described embodiments, and various variations and modifications may be possible without departing from the scope of the present invention. For example, it is possible for the embodiments to be implemented in combination as appropriate.

A radio communication apparatus according to the present invention can be installed in a communication terminal apparatus and base station apparatus in a MIMO radio communication type of mobile communication system, thereby enabling a communication terminal apparatus, base station apparatus, and mobile communication system to be provided that have the same kind of effects as described above.

A case has here been described by way of example in which the present invention is configured as hardware, but it is also possible for the present invention to be implemented by software. For example, the same kind of functions as those of a MIMO radio communication system according to the present invention can be realized by writing an algorithm of an antenna selection method according to the present invention in a programming language, storing this program in memory, and having it executed by an information processing section.

The present application is based on Chinese Patent Application No. 200510108560.X filed on Sep. 30, 2005, the entire content of which is expressly incorporated herein by reference.

### INDUSTRIAL APPLICABILITY

An antenna selection method according to the present invention is suitable for use in transmitting antenna selection in a MIMO radio communication system or the like.

1. An antenna selection method used in a MIMO (Multi Input Multi Output) radio communication system, comprising:
a first step of arbitrarily selecting K columns (where K is a natural number greater than 0 and less than or equal to M) from an M-column channel estimation matrix composed of all of M transmitting antennas (where M is a natural number greater than 1) and configuring C_{M}^{K} selection determination channel matrices;
a second step of performing QR decomposition respectively on the C_{M}^{K} selection determination channel matrices and obtaining C_{M}^{K} upper triangular matrices;
a third step of finding a diagonal element minimum modular value of each of the C_{M}^{K} upper triangular matrices;
a fourth step of selecting one upper triangular matrix for which the diagonal element minimum modular value is largest from among the C_{M}^{K} upper triangular matrices; and
a fifth step of selecting K transmitting antennas composing a selection determination channel matrix corresponding to an upper triangular matrix selected in the fourth step as emission antennas.

2. The antenna selection method according to claim 1, further comprising:
a sixth step of configuring an emission channel matrix composed of K emission antennas selected in the fifth step;
a seventh step of performing QR decomposition on the emission channel matrix and obtaining an upper triangular matrix;
an eighth step of calculating an SNR (Signal to Noise Ratio) of the K emission antennas using a diagonal element modular value of an upper triangular matrix obtained in the seventh step; and
a ninth step of performing power distribution and modulation method selection for the K emission antennas based on the SNR.

3. An antenna selection method used in a MIMO (Multi Input Multi Output) radio communication system, comprising:
a first step of selecting columns corresponding to already selected I−1 emission antennas (where I is a natural number greater than 0) from an M-column channel estimation matrix composed of all of M transmitting antennas (where M is a natural number greater than 1) and configuring an I−1-column emission channel matrix;
a second step of selecting columns corresponding to M−I+1 candidate transmitting antennas other than the I−1 emission antennas from the channel estimation matrix and configuring an M−I+1-column candidate channel matrix;
a third step of adding one arbitrary column of the candidate channel matrix to the emission channel matrix and configuring M−I+1 selection determination channel matrices;
a fourth step of performing QR decomposition on the M−I+1 selection determination channel matrices and obtaining M−I+1 upper triangular matrices;
a fifth step of finding a diagonal element minimum modular value of each of the M−I+1 upper triangular matrices;
a sixth step of selecting one upper triangular matrix for which the diagonal element minimum modular value is largest from among the M−I+1 upper triangular matrices; and
a seventh step of selecting one the candidate transmitting antenna composing a selection determination channel matrix corresponding to an upper triangular matrix selected in the sixth step as an I'th emission antenna,
wherein the first step, the second step, the third step, the fourth step, the fifth step, the sixth step, and the seventh step are repeated K times (where K is a natural number greater than 0), and emission antennas are selected one by one up to K emission antennas.

4. The antenna selection method according to claim 3, further comprising:
an eighth step of configuring an emission channel matrix composed of selected K emission antennas;
a ninth step of performing QR decomposition on the emission channel matrix and obtaining an upper triangular matrix;
a tenth step of calculating an SNR (Signal to Noise Ratio) of the K emission antennas using a diagonal element modular value of an upper triangular matrix obtained in the ninth step; and
an eleventh step of performing power distribution and modulation method selection for the K emission antennas based on the SNR.

5. A radio communication apparatus used in a MIMO (Multi Input Multi Output) radio communication system, comprising:
M transmitting antennas (where M is a natural number greater than 1); and
a selection section that executes selection processing that selects K emission antennas (where K is a natural number greater than 0 and less than or equal to M) from the M transmitting antennas based on an M-column channel estimation matrix composed of all the M transmitting antennas,
wherein the selection section executes the selection processing that includes:
a first step of arbitrarily selecting K columns from the channel estimation matrix and configuring C_{M}^{K} selection determination channel matrices;
a second step of performing QR decomposition respectively on the C_{M}^{K} selection determination channel matrices and obtaining C_{M}^{K} upper triangular matrices;
a third step of finding a diagonal element minimum modular value of each of the C_{M}^{K} upper triangular matrices;
a fourth step of selecting one upper triangular matrix for which the diagonal element minimum modular value is largest from among the C_{M}^{K} upper triangular matrices; and
a fifth step of selecting K transmitting antennas composing a selection determination channel matrix corresponding to an upper triangular matrix selected in the fourth step as emission antennas.

6. The radio communication apparatus according to claim 5, further comprising a power distribution/modulation method selection section that performs power distribution and modulation method selection processing for the K emission antennas, wherein the power distribution/modulation method selection section executes the power distribution/modulation method selection processing that includes:
a sixth step of configuring an emission channel matrix composed of the K emission antennas;
a seventh step of performing QR decomposition on the emission channel matrix and obtaining an upper triangular matrix;
an eighth step of calculating an SNR (Signal to Noise Ratio) of the K emission antennas using a diagonal element modular value of an upper triangular matrix obtained in the seventh step; and
a ninth step of performing power distribution and modulation method selection for the K emission antennas based on the SNR.

7. A radio communication apparatus used in a MIMO (Multi Input Multi Output) radio communication system, comprising:
M transmitting antennas (where M is a natural number greater than 1); and
a selection section that executes selection processing that selects K emission antennas (where K is a natural number greater than 0 and less than or equal to M) from the M transmitting antennas based on an M-column channel estimation matrix composed of all the M transmitting antennas, wherein the selection section executes the selection processing that includes:
a first step of selecting columns corresponding to already selected I−1 emission antennas (where I is a natural number greater than 0) from the channel estimation matrix and configuring an I−1-column emission channel matrix;
a second step of selecting columns corresponding to M−I+1 candidate transmitting antennas other than the I−1 emission antennas from the channel estimation matrix and configuring an M−I+1-column candidate channel matrix;
a third step of adding one arbitrary column of the candidate channel matrix to the emission channel matrix and configuring M−I+1 selection determination channel matrices;
a fourth step of performing QR decomposition on the M−I+1 selection determination channel matrices and obtaining M−I+1 upper triangular matrices;
a fifth step of finding a diagonal element minimum modular value of each of the M−I+1 upper triangular matrices;
a sixth step of selecting one upper triangular matrix for which the diagonal element minimum modular value is largest from among the M−I+1 upper triangular matrices;
and
a seventh step of selecting one the candidate transmitting antenna composing a selection determination channel matrix corresponding to an upper triangular matrix selected in the sixth step as an I'th emission antenna, and
repeats the first step, the second step, the third step, the fourth step, the fifth step, the sixth step, and the seventh step K times (where K is a natural number greater than 0) and selects emission antennas one by one up to K emission antennas.

8. The radio communication apparatus according to claim 7, further comprising a power distribution/modulation method selection section that performs power distribution and modulation method selection processing for the K emission antennas,
wherein the power distribution/modulation method selection section executes the power distribution/modulation method selection processing that includes:
an eighth step of configuring an emission channel matrix composed of the K emission antennas;
a ninth step of performing QR decomposition on the emission channel matrix and obtaining an upper triangular matrix;
a tenth step of calculating an SNR of the K emission antennas using a diagonal element modular value of an upper triangular matrix obtained in the ninth step; and
an eleventh step of performing power distribution and modulation method selection for the K emission antennas based on the SNR.
